(19) United States
(12) Patent Application Publication
(10) Pub. No.: US 2017/0212722 A1
(43) Pub. Date: Jul. 27, 2017

(54) APP-BASED PLATFORM FOR SYNCHRONIZING USER-GENERATED ANIMATION WITH MUSIC

(71) Applicant: Christian Grant Campbell, Newtown Square, PA (US)

(72) Inventor: Christian Grant Campbell, Newtown Square, PA (US)

(21) Appl. No.: 15/006,596

(22) Filed: Jan. 26, 2016

(51) Int. Cl. G06F 3/16; G06T 13/80; G10H 1/36

(52) U.S. Cl. CPC G06F 3/165; G10H 1/36; G06T 13/80; G06T 2213/08; G10H 2220/021

(57) ABSTRACT

Disclosed is a platform enabling users to generate animations synchronized to a musical track in an app-based environment which facilitates collaboration. A method of generating such animations involves first receiving, by a host device executing an app input data from one or more input devices. The app utilizes a layers module to assign the input data to one or more layers. The app assigns input data to layers and allows modification of inputs and timestamps of the input data. The app further allows application of one or more media assets to the inputs. Users of the platform may each execute the app, or execute a companion app that allow communication to the host device. The app may also facilitate compiling the one or more layers into a musical animation file. The musical animation file may store the one or more layers and metadata identifying the musical track.

### CLAIM OF PRIORITY

This application claims priority to U.S. Provisional Patent Application Ser. No. 62/265,622, filed Dec. 10, 2015, the entire disclosure of which is hereby expressly incorporated by reference herein.

### FIELD OF TECHNOLOGY

This disclosure relates generally to data processing devices and, more particularly, to a method and a system of real-time generation of animations synchronized to music by one or more users on a collaborative platform.

### BACKGROUND

Current methods for creating illustrative and/or interpretive visualizations of musical compositions involve extensive software skills, expert knowledge of musical composition. Additionally, they require computing devices with extensive central or graphics processing power. Lastly, current software-based visualization tools, which simply listen to a song and interpolate rhythmic, chordal and tonal parameters do an inadequate job of representing all the nuances of a music performance. Software-based visualization tools modulate waveforms quantitatively, resulting in inorganic visualizations that do not reflect the imperfect nature of music. Current systems for creating animation that are synchronized with music, especially automatically, are inordinately expensive and inaccessible by the general public. Furthermore, robotic synchronization of animation to music requires extensive time expenditures, significant expertise.

As can be seen, there is a need for systems that can create illustrative animations synchronized with music that take advantage of conventional, widely available user input devices.

### SUMMARY

Disclosed are a method and a system of real-time generation of animations synchronized to music by one or more users on a collaborative platform.

In one aspect, a method of generating visualizations for a musical track through a collaborative platform involves first receiving, by a host device executing an app, input data from one or more input devices communicatively coupled to the host device. The app comprises a layers module configured to assign the input data to one more layers. The method further involves modifying one or more inputs and one or more timestamps of the input data. The method also involves applying one or more media assets to the one or more inputs.

A system of generating visualizations for a musical track through a collaborative platform comprises an intranet of one or more input devices, at least one of the one or more input devices being designated as a host device. The host device executes an app comprising instructions that when executed by the host device causes the host device to receive, through the processor of the host device, input data from one or more input devices through the intranet. The app comprises further instructions for modifying one or more inputs and one or more timestamps of the input data. The app also comprises instructions for applying one or more media assets to the one or more inputs. The app further comprises a layers module configured to assign the input data to one or more layers.

An app-based platform for collaboratively generating visualizations for a musical track comprises a data processing device storing one or more instructions in an app. When executed by a processor of the data processing device, the one or more instructions cause the data processing device to receive, by the processor of the data processing device, input data generated by at least one of the data processing device and one or more input devices. The one or more instructions also cause the data processing device to assign the input data to one or more layers. The app comprises further instructions for providing a user interface for modifying one or more inputs and one or more timestamps of the input data. The app also comprises instructions for applying one or more media assets to the one or more inputs.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic diagram of a system of real-time generation of animations on a collaborative platform, according to one or more embodiments.

FIG. 2 is a block diagram of a server of the system of FIG. 1, according to one or more embodiments.

FIG. 3 is a process flowchart illustrating a method of the system of FIG. 1 comprising an input device and a data processing device executing an app, according to one or more embodiments.

FIG. 4 is a process flowchart illustrating a method of the system of FIG. 1 comprising an input device embodied in a data processing device executing an app, according to one or more embodiments.

Other features of the present embodiments will be apparent from the accompanying drawings and from the detailed description that follows.

### DETAILED DESCRIPTION

Example embodiments, as described below, may be used to provide a method and a system of real-time generation of animations synchronized to music by one or more users on a collaborative platform.

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure provide an app-based platform for real-time creation of animations synchronized with a predetermined musical track.

“Animations” may also be expressed as “visualizations”. “App” may refer to any set of instructions executable by a data processing device (e.g. smartphone, personal computer, microphone, video camera, etc.). All iterations of “input device” may refer to: a stand-alone data processing device capable of executing apps; an application-specific integrated circuit (ASIC) configured for use with a data processing device and/or independently configured to establish a connection to the server through the network; a peripheral device communicatively coupled to the data processing device; or a module integrated within the data processing device.

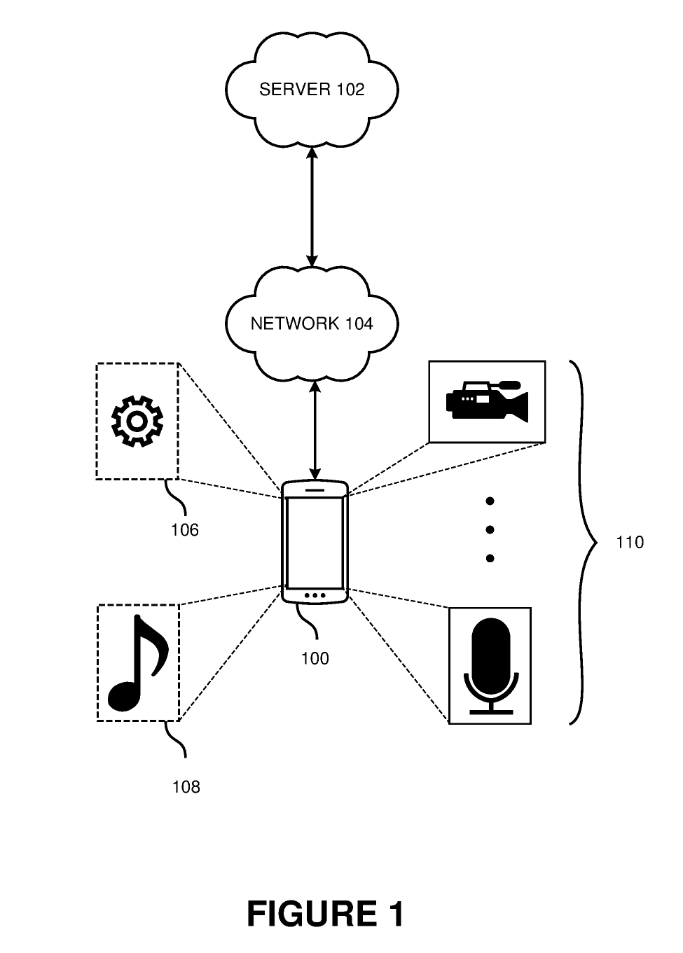

Reference is now made to FIG. 1, which is a schematic diagram of a system of real-time generation of animations on a collaborative platform, according to one or more embodiments. The system may comprise a data processing device 100 communicatively coupled to a server 102 through a network 104. Any number of data processing devices may be communicatively coupled to the server 102 through the network 104. The data processing device(s) 100 may utilize any number of communication protocols to communicate data to the server 102 and to the other data processing devices, including Wi-Fi™, Wi-Fi Direct™, AirPlay®, Bluetooth 4.0, Bluetooth Low Energy, NFC, infrared, Zigby, etc.

In one embodiment, the data processing device 100 may embody any number of input devices 110 (video camera, microphone, GPS, gyroscope, accelerometer, etc.). In another embodiment, the data processing device 100 may be a host device and may be communicatively coupled to one or more stand-alone input devices 110.

The data processing device 100 may execute an app 106. The app 106, when executed by a processor of the data processing device 100, may enable any number of users to collaborate in the animation creation process. The app 106 may provide an interface configured for interacting with a musical track 108 played back by the data processing device 100 (e.g. through the app 106 or another media player of the data processing device 100 or a server (e.g. server 102) streaming the music to the data processing device 100 through the network 104). The musical track 108 may be stored in a local storage (e.g. a volatile memory or a non-volatile of the data processing device 100) or may be streamed from the server 102.

The interface may be adapted to receive inputs from any input device that can generate input data and communicate the input data to the data processing device 100. The input device(s) may include any commercially available touchscreen, motion sensing sensor, video camera, microphone, and/or gyroscope/accelerometer. Other input devices or peripheral devices may be used to generate input data and are within the scope of the exemplary embodiments described herein. Input data may hereinafter be referred to as “input” and may comprise any form of interaction with an input device (integrated into the data processing device 100), such as a tap on a touchscreen, a shake of a gyroscope/accelerometer, or a sound recorded by a microphone. Other types of input devices and input data may be used and are within the scope of the exemplary embodiments described herein.

One or more data processing devices each having one or more input devices 110 may be used individually, concurrently, or sequentially by one or more users. One of the one or more data processing devices may be designated as a host and may execute the app 106; the one or more data processing devices may be communicatively coupled to the host through the network 104. The one or more data processing devices may also execute the app 106 or may execute a companion app allowing connected devices to transmit data to the host.

The app 106 may be used individually or collectively, allowing any number of users to create and capture inputs in real-time during the playback of the musical track 108. The inputs may be post-processed after creation, during which assignments and modifications may be made to the inputs prior to rendering. For example, animations may be assigned to inputs, the inputs may be moved temporally within the timeline of the musical track 108. The final product is a compiled musical animation file, containing all of the inputs recorded through the app 106. Within the file may be additional information about the musical track 108. Though the actual musical track 108 need not be stored in order to prevent copyright infringement, the media tags (such as ID3 tags) may be stored and may include data such as Title, Artist, Album, Year, Genre, Comments, etc. Other data or metadata may be included in the compiled musical animation file and may be within the scope of the exemplary embodiments discussed herein.

The animation process involves first recording inputs from the one or more input devices 110 during regular playback of music. In the app 106, each type of input device may be classified according to its corresponding input device. For example, an input may be: a tap, forceful press, drag, spin, etc. on a touchscreen-enabled input device or a shake, abstract air gesture with an accelerometer/gyroscope-enabled input device.

Inputs received through the one or more input devices 110 may each be featured as a separate layer of the final animation. A layer is a digital representation of the sum of a user's and the input device's synchronous or asynchronous movements or inputs over a predetermined amount of time. Any of number of layers may be superimposed in any order and later compiled as a musical animation file designated for the musical track 108.

During this recording process, inputs may be assigned to timestamps throughout the timeline of the musical track 108. The timestamps may be formed automatically when the input is received or based on a user prompt. After the recording process, a user may alter timestamps. For example, a user may alter a timestamp to improve synchronicity between an input and an aspect of the musical track 108. Alternately, the timestamp may be altered to cause the input and the aspect of the musical track 108 to be asynchronous.

Data input from touchscreen devices may be a spatial representation of the touch screen coordinates; for example, if a user is representing a drumbeat by tapping in the bottom left corner of a touch screen, these taps will be recorded in the corresponding layer in the app 106. As with pressure-based touches, a firmer drag of a finger across the touchscreen will also represent greater emphasis, as with a firmer press of a brush on a canvas.

For gestures using either shaking or abstract air gestures, a user will first define their field of animation by virtually specifying the approximated 2D space of coordinates with their input device, similar to dragging a box on a 2D touch screen. After such setup, a user may record inputs within the 2D space of coordinates, while the app 106 calculates the coordinates based on input from the gyroscope and/or accelerometer. The app 106 may be also be configured to designate a three-dimensional referential frame and calculate coordinates based on said frame. Such a configuration would be optimal for generating three-dimensional visualizations synchronized to music.

Other input devices based on a variety of human interfaces may also be used and are included within the exemplary embodiments described herein. Such human interface devices include handheld input devices such as styli, wearable devices such as smartwatches, video cameras, or sound recorders. Video cameras may be used to capture video or still photos. Microphones may be used to record sound from an individual or ambient sound, or to capture a digital representation of the relative volume or user-generated sound effects.

The animation process further involves post-processing, during which the user(s) of the input device(s) may apply any number of illustrations, animations, shapes, objects, effects, images, videos, etc. from a library to the inputs of any of the layers. The users may be limited to altering only their own layers or may be allowed to work on any layer. Layers may be set to read-only or read/write by a host of the animation process or an owner of the layer; the host of the animation process may be one of the input devices 110 or may be a server communicatively coupled to the input devices 110; the owner may be the user(s) responsible for composition of the layer. The library may be stored in a memory of any input device or may be hosted by the host of the animation process.

Anytime during the animation process, a user may modify any attributes of one or more layers or one or more inputs by accessing the specific input or layer. Attributes that may be changed include a temporal, physical and/or spatial representation of any input or layer (e.g. when and where the input was received on a touchscreen, the type of input that was received (e.g. a tap vs. a drag), the duration of the input, etc.); the size, breadth, and positioning of a layer relative to other layers (e.g. how much visual space the layer takes up, how many inputs the layer embodies, order in which the layers are compiled, etc.), and other attributes that may be useful during the animation process.

Upon completion, the app 106 may compile all layers and compile them into a musical animation file. The file may be shared between data processing devices. Also, the file may be communicated through the network 104 to the server 102. Alternately, the file may be communicated through a social media platform and hosted on the server 102 or on a server of the social media platform. Once hosted on the server 102 (or another centralized server environment), the file may be catalogued and searchable and available for download by anyone else with the app 106 or alternate access to the server 102. Alternately, the file may be communicated directly between devices through Bluetooth or any other personal area network (PAN). If available, the file may also be viewed on any communicatively coupled TV, virtual reality headset, screen projector, screen at a live event, or another input device.

Unlike current visualization software or platforms which have sophisticated processor requirements and/or a steep learning curve, the embodiments described herein will enable music enthusiasts, creative designers, and amateur animators (with limited complex software literacy) to create their own unique audio-visual composition for sharing with the world. This platform will also prove useful to educators illustrating the complexities of a musical composition; DJ's to accompany their live light shows; musical artists for creating new music videos; professional animators looking for a simpler way to create user-friendly musical animations; or hearing impaired people to help them better appreciate music.

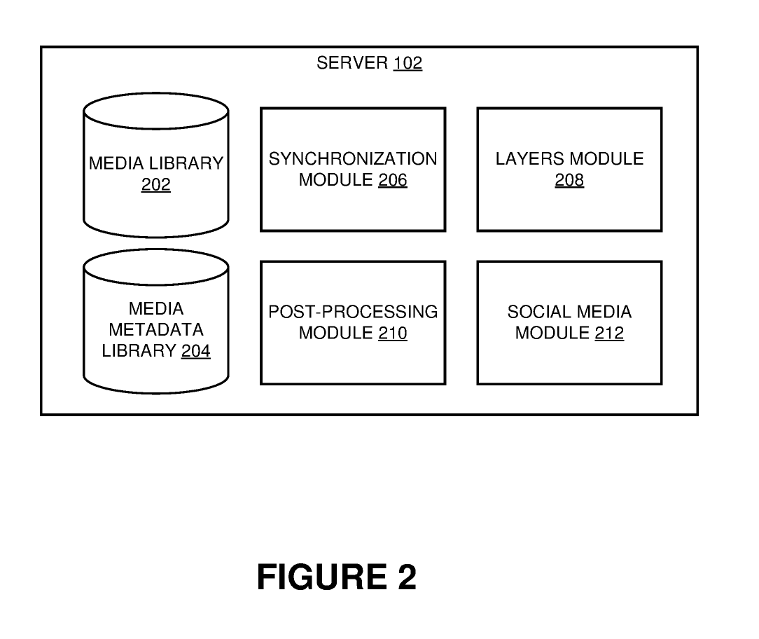

Reference is now made to FIG. 2, which is a block diagram of a server 102 of the system of FIG. 1, according to one or more embodiments. The server 102 may comprise one or more libraries and one or more modules integral to the operation of the app-based platform. In one embodiment, the server 102 may comprise a media library 202, a media metadata library 204, a synchronization module 206, a layers module 208, a post-processing module 210, and a social media module 212.

The media library 202 may comprise any number and type of illustrations, animations, shapes, objects, effects, images, videos, etc. The media library 202 may be accessed by a data processing device (e.g. the host device) during the animation process. For example, a user wishing to apply an animation of a rolling ball may be able to search for and select such an animation from the media library 202. Aspects of the media library 202 may require payment in order to gain access. Payment may be process through the app or through an external merchant website.

The media metadata library 204 may be a database storing metadata identifying one or more musical tracks. The media metadata library 204 may be a starting point for a group of collaborating animators. For example a group of friends may desire to animate a popular music track for which they share an affinity. They may access the media metadata library 204 through the app, search for the popular music track, select it, and begin recording their inputs once playback begins.

In another embodiment, a user desiring to animate a musical track stored locally on a memory of their respective data processing device may not require the media metadata library 204. Rather, in this embodiment, the app may be able to identify the musical track, record metadata, and playback the song from the local memory. Alternately, the app may be able to load the musical track and play it back without the need for metadata to be stored. In such a case, the metadata may be input manually, or may be automatically provided once a connection to the server through the network is reestablished. Alternately, in an intranet of data processing devices generating animations collaboratively through the app, the data processing devices may retrieve the metadata for the musical track from the host. The host may comprise the media metadata library 204 or the metadata may be input manually by the host.

When the musical animation file is compiled and shared, the musical animation file may comprise the metadata for the musical track. Alternately, the musical animation file may comprise the musical track, especially if the musical track was stored locally. In the case that a musical animation file storing only metadata for the musical track is shared, a data processing device viewing the musical animation file may search for the musical track locally by using the stored metadata as one or more search terms. If the musical track is not found locally, then the data processing device may search one or more streaming services to gain access to the musical track. The streaming services may be available through the app or another app.

The synchronization module 206 may be a set of tools and/or a database accessible through the app and configured to relate timestamps to specific inputs. The layers module 208 may be responsible for classifying inputs according to their type and assigning inputs from separate input devices into corresponding layers. The post-processing module 210 may be a set of tools for making changes to layers. Features of the synchronization module 206, the layers module 208 and the post-processing module 210 may overlap or the synchronization module 206, the layers module 208 and the post-processing module 210 may actually be a single module that is loaded by the app every time. Any combination or function of the synchronization module 206, the layers module 208 and the post-processing module 210 is contemplated and within the scope of the exemplary embodiments discussed herein.

The social media module 212 may introduce the API of one or more social media outlets such as Facebook®, Twitter®, Tumblr®, Pinterest®, etc. to facilitate sharing of musical animation files. It is expected that a PHOSITA would appreciate such a prevalent feature.

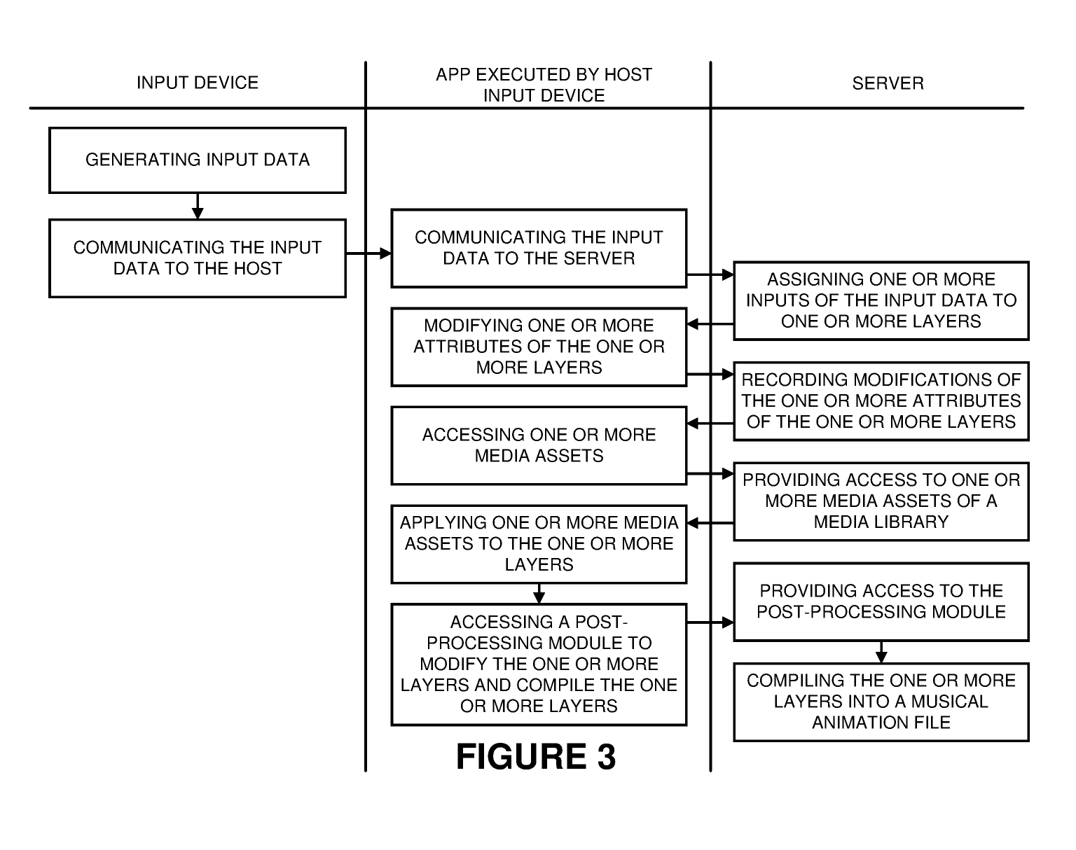

Reference is now made to FIG. 3, which is a process flowchart illustrating a method of the system of FIG. 1 comprising an input device and a data processing device executing an app, according to one or more embodiments. In FIG. 3, the input device is separate from the data processing device, which is the host and also executes the app and communicates to the server. For example, a user having a host smartphone may connect a MIDI guitar to the host smartphone via micro-USB, Thunderbolt™, or other connection. The midi guitar may be used to produce musical input data that is layered on top of a musical track. In this example, the input device generates input data and communicates the input data to the host through a controller of the MIDI guitar. The app communicates the input data to the server and proceeds to request access to and utilize one or more libraries and/or modules (as in FIG. 2) to generate a musical animation file.

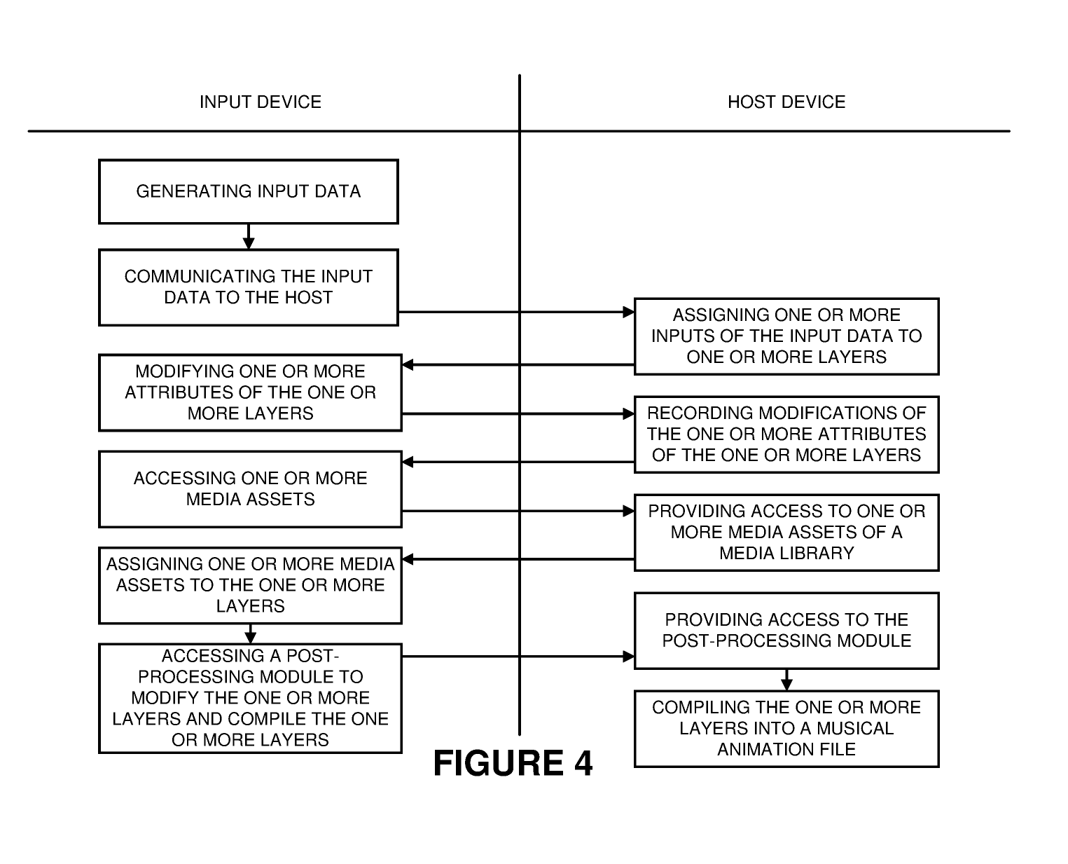

Reference is now made to FIG. 4, which is a process flow illustrating a method of the system of FIG. 1 comprising an input device embodied in a data processing device executing an app, according to one or more embodiments. In FIG. 4, the input device is embodied within the data processing device (e.g. a smartphone). As such, the input device may be an integrated chip or board. For example, the input device may be a 6-axis gyroscope that may sense the attitude of the smartphone (pitch, yaw, roll) or may be an accelerometer that may detect movement within three-dimensional space. In any case, the input device communicates the input data to the processor of the data processing device, which is subsequently communicated to the host, which is the server in this case. The method proceeds with the data processing device requesting access to and utilizing one or more libraries and/or modules (as in FIG. 2) to generate a musical animation file.

In another embodiment of the system of FIG. 1, the data processing device (host) may perform all the functions of the server. As such, the one or more data processing device(s), including the host, and the one or more input devices may communicate within an intranet, but not to the server through the network. In one embodiment, the host, or any other data processing device or any of the one or more input devices, may be responsible for facilitating the functions of the system in that it stores the one or more libraries and the one or modules locally. In another embodiment, all of the devices involved may locally store the one or more libraries and/or the one or more modules. In this embodiment, inputs can be rendered locally, either by the host or any of the data processing devices or input devices being used to generate inputs, assign inputs to layers, modify the inputs and/or layers, and compile the layers into a musical animation file.

Although the present embodiments have been described with reference to specific example embodiments, it will be evident that various modifications and changes may be made to these embodiments without departing from the broader spirit and scope of the various embodiments. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of generating visualizations for a musical track through a collaborative platform comprising:
receiving, by a host device executing an app, input data from one or more input devices communicatively coupled to the host device,
wherein the app comprises a layers module configured to assign the input data to one more layers,
modifying one or more inputs and one or more timestamps of the input data, and
applying one or more media assets to the one or more inputs.

2. The method of claim 1, further comprising:
compiling the one or more layers into a musical animation file, wherein the compiled musical animation file comprises the one or more layers and metadata identifying the musical track.

3. The method of claim 2, wherein the metadata is retrieved from a media metadata library of the host device.

4. The method of claim 3, wherein the one or more media assets are retrievable through a media library of the host device.

5. The method of claim 4, wherein any one or more of the one or more input devices hosts one or more module or library of the host device.

6. The method of claim 1, further comprising:
wherein the one or more input devices execute companion apps configured to communicate input data to the host device, and
wherein the companion apps perform a subset of the functions of the app executed by the host device.

7. The method of claim 1, wherein the one or more input devices are communicatively coupled to the host device through a network.

8. A system of generating visualizations for a musical track through a collaborative platform comprising:
an intranet of one or more input devices, at least one of the one or more input devices being designated as a host device, wherein the host device executes an app comprising instructions that when executed by the host device causes the host device to:
receive, through the processor of the host device, input data from one or more input devices through the intranet,
wherein the app comprises a layers module configured to assign the input data to one or more layers,
modify one or more inputs and one or more timestamps of the input data,
apply one or more media assets to the one or more inputs.

9. The system of claim 8, wherein the app is further configured to:
compile the one or more layers into a musical animation file, wherein the compiled musical animation file comprises the one or more layers and metadata identifying the musical track.

10. The system of claim 9, wherein the metadata is retrieved from a media metadata library of the host device.

11. The system of claim 10, wherein the one or more media assets are retrievable through a media library of the host device.

12. The system of claim 11, wherein any one or more of the one or more input devices hosts one or more module or library of the host device.

13. The system of claim 8, further comprising:
wherein the one or more input devices execute companion apps configured to: communicate input data to the host device, and
wherein the companion apps comprise a subset of the instructions of the app executed by the host device.

14. The system of claim 8, wherein the one or more input devices are communicatively coupled to the host device through a network.

15. An app-based platform for collaboratively generating visualizations for a musical track comprising:
a data processing device storing one or more instructions in an app that when executed by a processor of the data processing device cause the data processing device to:
receive, by the processor of the data processing device, input data generated by at least one of the data processing device and one or more input devices;
assign the input data to one or more layers;
provide a user interface for modifying one or more inputs and one or more timestamps of the input data; and
apply one or more media assets to the one or more inputs.

16. The platform of claim 15, wherein the app further comprises a media library comprising one or more media assets which may be applied to the one or more inputs.

17. The platform of claim 15, wherein the app further comprises a media metadata library comprising one or more metadata identifying one or more musical tracks.

18. The platform of claim 15, wherein the app further comprises a synchronization module configured to modify the one or more inputs and the one or more timestamps.

19. The platform of claim 15, wherein the app further comprises a layers module configured to assign the input data to the one or more layers.

20. The platform of claim 15, further comprising a post-processing module configured to modify the one or more layers and compile the one or more layers into a musical animation file.
